(19) United States
(12) Patent Application Publication
(10) Pub. No.: US 2009/0121976 A1
(43) Pub. Date: May 14, 2009

(54) Plasma display device and driving method thereof

(76) Inventors: Youn-Kyoung Kim, Suwon-si (KR); Jang-Ho Moon, Suwon-si (KR); Jung-Jin Choi, Suwon-si (KR); Hyun Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,184

(22) Filed: Oct. 22, 2008

(30) Foreign Application Priority Data
Nov. 14, 2007 (KR) 10-2007-0116128

(51) Int. Cl. G09G 3/28

(52) U.S. Cl. 345/60

(57) ABSTRACT

Wall charges of a turn-off cell selected from among a plurality of discharge cells are erased by applying an address voltage to a third electrode corresponding to the turn-off cell in an address period, and first and second pulse strings are respectively applied to first electrodes and second electrodes in a sustain period, where the first pulse string alternates between a first voltage and a second voltage higher than the first voltage, and the second pulse string has the same pattern as, but a different alternating timing from, the first pulse string. The sustain period includes an overlapping duration in which voltages of the first and second pulse strings are simultaneously higher than the first voltage.

### BACKGROUND OF THE INVENTION

1. Field of the Invention

Embodiments relate to a plasma display device and a driving method thereof. More particularly, embodiments relate to a method of controlling sustain pulses of a plasma display device.

2. Description of the Related Art

A plasma display device is a flat panel display that uses plasma generated by gas discharge to display characters or images. A display panel of the plasma display device includes, depending on its size, more than several scores to millions of discharge cells (hereinafter, simply called “cells”) arranged in a matrix pattern.

Generally, in a plasma display device, one frame is divided into respectively weighted subfields. Grayscales may be expressed by a combination of weights from among the subfields, which are used to perform a display operation. During an address period of each subfield, turn-on/turn-off cells are selected, During a sustain period, a sustain discharge is performed on the turn-on cells so as to display an image. During the address period, some of turn-on cells may be set as turn-off cells by erasing wall charges formed therein by address discharge. For this purpose, according to a typical plasma display device, in an initial subfield of each frame, all discharge cells are set as turn-on cells by performing a reset operation, and turn-off cells are selected during the address period. After the initial subfield, i.e., from a second subfield on, the reset operation is omitted, and turn-off cells are selected from the turn-on cells of a previous subfield.

According to such a conventional scheme, when a cell fails to sustain discharge during the sustain period due to a self-erasing in a subfield in a plurality of subfields in a frame, the sustain discharge failure may not be corrected. Thus, the sustain discharge failure will continue until the reset operation of an initial subfield of a next frame. In addition, when an address operation is performed when insufficient wall charges are formed due to a weak sustain discharge, a misfiring may occur at a cell that becomes unstable due to failure of an address discharge to set the cell as a turn-off cell.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a plasma display device and a driving method thereof, which substantially overcomes one or more of the problems and disadvantages of the related art.

It is a feature of an embodiment to provide a plasma display device and a driving method thereof having an improved stability of a sustain discharge while maintaining high power efficiency.

It is another feature of an embodiment to provide a plasma display device and a driving method thereof having a more uniform sustain discharge.

It is yet another feature of an embodiment to provide a plasma display device and a driving method thereof having reduced discharge spots and bright image sticking, while maintaining high power efficiency

At least one of the above and other features and advantages may be realized by providing a driving method of a plasma display device having a plurality of first, second, and third electrodes and a plurality of discharge cells defined by the plurality of first, second, and third electrodes, where the plurality of third electrodes extend in a direction that crosses the plurality of first and second electrodes. The exemplary driving method includes erasing wall charges of a turn-off cell selected from among the plurality of discharge cells by applying an address voltage to a third electrode corresponding to the turn-off cell in an address period, and applying a first pulse string to the plurality of first electrodes and a second pulse string to the plurality of second electrodes in a sustain period, the first pulse string alternating between a first voltage and a second voltage higher than the first voltage, the second pulse string having the same pattern as, but a different alternating timing from, the first pulse string. The sustain period includes an overlapping duration in which voltages of the first and second pulse string are simultaneously higher than the first voltage.

At least one of the above and other features and advantages may be realized by providing a plasma display device that includes a plasma display panel having a plurality of first, second, and third electrodes and a plurality of discharge cells defined by the plurality of first, second, and third electrodes, the plurality of third electrodes extending in a direction that crosses the plurality of first and second electrodes, and a driver coupled to the first, second, and third electrodes. The driver is configured to erase wall charges of a turn-off cell selected from among the plurality of discharge cells by applying an address voltage to a third electrode corresponding to the turn-off cell in an address period, and apply a first pulse string to the plurality of first electrodes and a second pulse string to the plurality of second electrodes in a sustain period, the first pulse string alternating between a first voltage and a second voltage higher than the first voltage, the second pulse string having the same pattern as, but a different alternating timing from, the first pulse string. The sustain period includes an overlapping duration in which voltages of the first and second pulse string are simultaneously higher than the first voltage.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a block diagram of a plasma display device according to an exemplary embodiment of the present invention;

FIG. 2 illustrates a subfield arrangement in a frame of a plasma display device according to an exemplary embodiment of the present invention;

FIG. 3 illustrates a driving waveform of a typical plasma display device;

FIG. 4 illustrates a sustain pulse string applied to a scan electrode Y and a sustain electrode X during a sustain period according to an exemplary embodiment of the present invention;

FIG. 5 illustrates another exemplary overlapping sustain pulse string according to an exemplary embodiment of the present invention; and

FIG. 6 illustrates still another exemplary overlapping sustain pulse string according to an exemplary embodiment of the present invention.

### DETAILED DESCRIPTION OF THE INVENTION

Korean Patent Application No. 10-2007-0116128, filed on Nov. 14, 2007, in the Korean Intellectual Property Office, and entitled: “Plasma Display Device and Driving Method Thereof,” is incorporated by reference herein in its entirety

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Throughout this specification and the claims which follow, unless explicitly described to the contrary, the word “comprise” or variations such as “comprises” or “comprising” will be understood to imply the inclusion of stated elements but not the exclusion of any other elements.

The wall charges described in the present specification are charges formed on a wall (e.g., a dielectric layer) close to each electrode of a discharge cell. The wall charges will be described as being “formed” or “accumulated” on the electrode, although the wall charges do not actually touch the electrodes. A wall voltage is a potential difference formed on the wall of the discharge cell by the wall charges.

Hereinafter, a plasma display device and a driving method thereof according to exemplary embodiments are described in detail with reference to accompanying drawings.

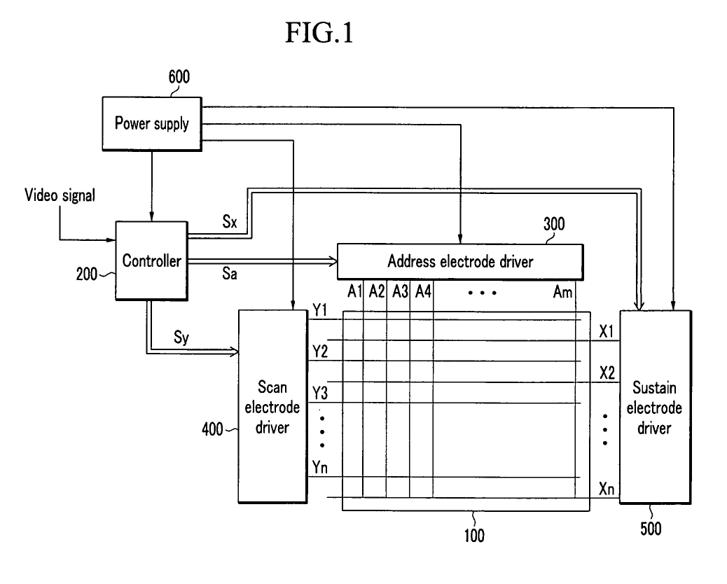

FIG. 1 illustrates a block diagram of a plasma display device according to an exemplary embodiment of the present invention. As shown in FIG. 1, a plasma display device may include a plasma display panel (PDP) 100, a controller 200, an address electrode driver 300, a scan electrode driver 400, a sustain electrode driver 500, and a power supply 600.

The PDP 100 may include a plurality of address electrodes A1 to Am extending in a column direction, and a plurality of sustain and scan electrodes X1 to Xn and Y1 to Yn extending in a row direction by pairs. The sustain electrodes X1-Xn may correspond to the scan electrodes Y1-Yn, and may be commonly connected to each other. The PDP 100 may include a substrate (not shown) where the sustain electrodes X1-Xn and the scan electrodes Y1-Yn are arranged, and another substrate (not shown) where the address electrodes A1-Am are arranged. The two substrates may face each other, and may be oriented such that the scan electrodes Y1-Yn and the address electrodes A1 to Am may perpendicularly cross and the sustain electrodes X1-Xn, and the address electrodes A1-Am may perpendicularly cross. A discharge space, between the two substrates, formed at a crossing region of the address electrodes A1-Am, with the sustain and scan electrodes X1-Xn and Y1-Yn, form a discharge cell. This is an exemplary structure of the PDP 100, and embodiments are applicable to other PDP structures.

The controller 200 may receive external video signals and may output an address electrode driving control signal Sa, a sustain electrode driving control signal Sx, and a scan electrode driving control signal Sy. In addition, the controller 200 may divide one frame into a plurality of subfields and may drive the subfields. Each subfield may include a reset period, an address period, and a sustain period.

The address electrode driver 300 may receive the address electrode driving control signal Sa from the controller 200 and may apply a display data signal to each address electrode so as to select turn-off cells from among turn-on cells. The scan electrode driver 400 may receive the scan electrode driving control signal Sy from the controller 200 and may apply a driving voltage to a scan electrode Y. The sustain electrode driver 500 may receive the sustain electrode driving control signal Sx from the controller 200 and may apply a driving voltage to a sustain electrode X. The power supply 600 may supply power for driving the plasma display device to the controller 200 and the respective drivers 300, 400, and 500.

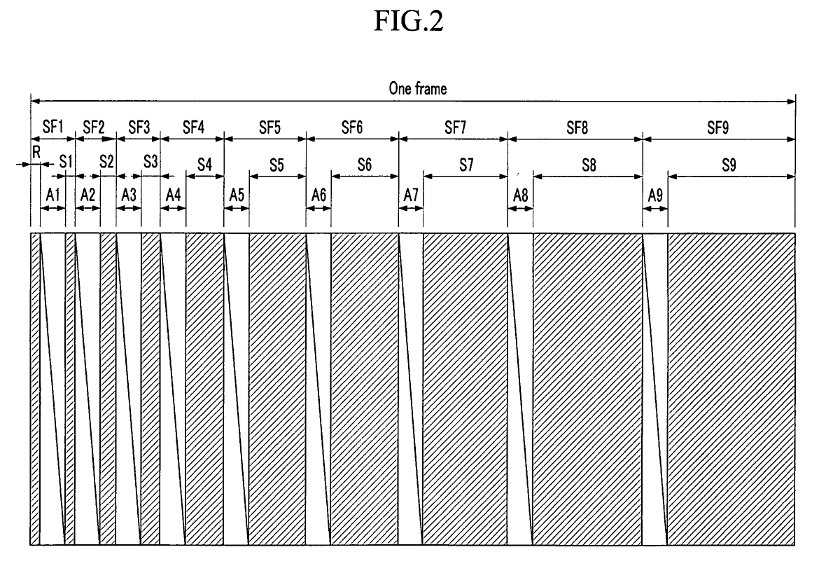

Hereinafter, a subfield arrangement in a frame of a plasma display device according to an exemplary embodiment of the present invention is described in detail with reference to FIG. 2. FIG. 2 exemplarily illustrates that nine subfields are included in one frame. However, a different number of subfields may be included in one frame.

As shown in FIG. 2, one frame may include a plurality of subfields SF1-SF9 that have respective luminance weight values. An initial subfield SF1 of the plurality of subfields SF1-SF9 may include a reset period R, an address period A1, and a sustain period S1, and other subfields SF2-SF9 respectively may include address periods A2-A9 and sustain periods S2-S9.

During the reset period R, wall charges may be accumulated at a plurality of cells defined by the address electrodes A1-Am, the sustain electrodes X1-Xn, and the scan electrodes Y1-Yn, so that these cells may be set as turn-on cells. During the address periods A1-A9 of respective subfields, an address discharge may be performed for cells to be turned-off among turned-on cells of a previous subfield such that turn-on cells and turn-off cells are newly selected. That is, during the address periods A1-A9, wall charges may be erased from selected turned-on cells of the previous subfield by the address discharge, so that they may become turned-off cells. During the sustain periods S1-S9 of respective subfields, the sustain discharge may be performed for the turn-on cells by periods corresponding to the luminance weight values of respective subfields, such that a desired image may be displayed.

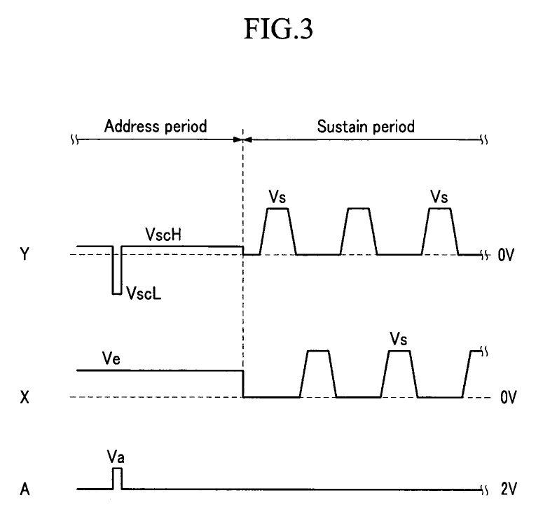

Hereinafter, a typical driving waveform of a plasma display device is described with reference to FIG. 3.

FIG. 3 illustrates a driving waveform of a typical plasma display device. The typical driving waveform of a plasma display device shown in FIG. 3 is for one of the subfields SF2-SF9 excluding the initial subfield SF1, in which the reset operation is performed, from among the plurality of subfields SF1-SF9 of one frame shown in FIG. 2. In addition, for better understanding and ease of description, FIG. 3 only illustrates a driving waveform for a scan electrode Y, a sustain electrode X, and an address electrode A that form a single cell.

Firstly, during the address period, a scan pulse having a VscL voltage (scan voltage) may be sequentially applied to a plurality of scan electrodes Y while a Ve voltage (erase voltage) may be applied to sustain electrodes X, in order to select turn-off cells. Simultaneously therewith, an address voltage Va may be applied to address electrodes A of turn-off cells from among a plurality of cells on the scan electrode applied with the VscL voltage. Thereby, an address discharge may be generated between the address electrode A receiving the address voltage Va and the scan electrode Y receiving the VscL voltage, and between the scan electrode Y receiving the VscL voltage and the sustain electrode X corresponding thereto, such that wall charges formed on the scan electrode Y, the address electrode A, and the sustain electrode X may be erased.

During the sustain period, sustain pulse strings that alternate between a high level voltage (Vs voltage in FIG. 3) and a low level voltage (0V in FIG. 3) may be applied to the scan electrode Y and the sustain electrode X with an opposite phase and no overlap. Here, a pulse string refers to a group of pulses that consecutively alternate at a predetermined frequency.

By such sustain pulse strings, 0V voltage is applied to the sustain electrode X when the Vs voltage is applied to the scan electrode Y, and the 0V voltage is applied to the scan electrode Y when the Vs voltage is applied to the sustain electrode X. By the Vs voltage and the wall voltage formed between the scan electrode Y and the sustain electrode X by the address discharge, a sustain discharge occurs between the scan electrode Y and the sustain electrode Y. The application of the sustain pulses to the scan electrode Y and the sustain electrode X may be repeated by a number corresponding to the weight value of respective subfields.

When the sustain discharge occurs in the sustain period by applying the 0V voltage to the scan electrode Y and the Vs voltage to the sustain electrode X, positive wall charges are accumulated on the scan electrode Y and the address electrode A, and negative wall charges are accumulated on the sustain electrode X. When the voltage of the sustain electrode X is then decreased to 0V, both the sustain electrode X and the scan electrode Y are at 0V voltage, i.e., there is no overlap, the potential of the address electrode A becomes higher than the potential of the sustain electrode due to the accumulated wall charges. In this case, a weak discharge may occur between the address electrode A and the sustain electrode X. This weak discharge may erase wall charges, a phenomenon referred to hereinafter as “self-erasing”. In the same manner, self-erasing may occur when the voltage of the scan electrode Y is decreased to 0V while maintaining the voltage of the sustain electrode X at 0V after the sustain discharge have occurred by applying 0V voltage to the sustain electrode X and the Vs voltage to the scan electrode Y. When the self-erasing occurs, the wall voltage between the scan electrode Y and the sustain electrode X decreases. Therefore, discharge due to the sustain pulse string is weakened, and thereby, the sustain discharge may not be formed as desired.

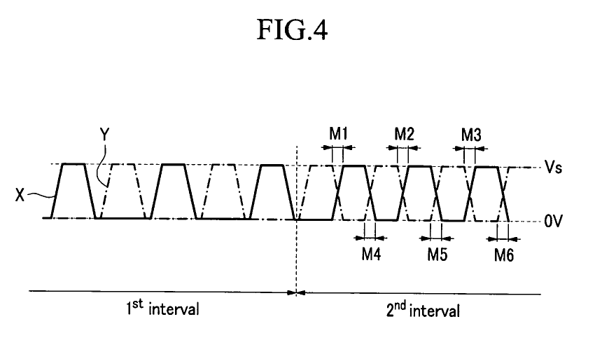

Hereinafter, a driving waveform of a plasma display device according to an exemplary embodiment of the present invention that may reduce or prevent the above-mentioned self-erasing is described in detail with reference to FIG. 4. The driving waveform of shown in FIG. 4 differs from a conventional driving waveform. In particular, a sustain pulse string shown in FIG. 4 applied to the scan electrode Y and the sustain electrode X in the sustain period differs from the non-overlapping sustain pulse string shown in FIG. 3.

Referring to FIG. 4, the sustain period may include a first interval and a second interval. In addition, in FIG. 4, the voltage of the sustain electrode X is illustrated as a solid line, and the voltage of the scan electrode Y is illustrated as a dotted line.

As shown in FIG. 4, in the first interval of the sustain period, the scan electrode Y and the sustain electrode X are simultaneously at 0V, i.e., do not simultaneously receive voltages higher than 0V (hereinafter called a non-overlapping sustain pulse string).

In the second interval of the sustain period, falling periods (i.e., time periods where a voltage of an electrode is decreased from the Vs voltage to 0V) of the scan electrode Y and rising periods (i.e., time periods where a voltage of an electrode is increased from 0V to the Vs voltage) of the sustain electrode X may overlap during periods M1-M3. In addition, rising periods of the scan electrode Y and falling periods of the sustain electrode X may overlap during to M4-M6. Hereinafter, a sustain pulse string that enables simultaneous application of voltages higher than 0V to the scan electrode Y and the sustain electrode X is called an overlapping sustain pulse string.

During the second interval, an overlapping sustain pulse string is applied to the scan electrode Y and the sustain electrode X. Therefore, the voltage of the sustain electrode X is always higher than 0V when the voltage of the scan electrode Y is 0V, and the voltage of the scan electrode Y is always higher than 0V when the voltage of the sustain electrode X is 0V. Therefore, self-erasing may be prevented, and accordingly, the sustain discharge may become more stable.

According to the present embodiment, the overlapping sustain pulse string and the non-overlapping sustain pulse string may be both employed in the sustain period as shown in FIG. 4. In this regard, the overlapping sustain pulse string enables the sustain discharge to become more stable. However, such an overlapping sustain pulse string may deteriorate luminance with respect to power consumption. Therefore, better power efficiency and stability of the sustain discharge may be obtained by applying the overlapping sustain pulse string to the scan electrode Y and the sustain electrode X for only part of the sustain period, i.e., during the second interval, and the non-overlapping sustain pulse string may be applied during another part of the sustain period, i.e., the first interval.

In FIG. 4, the first interval where the non-overlapping sustain pulse string is applied and the second interval where the overlapping sustain pulse string is applied are illustrated as being of similar duration. However, the length of the first interval may be longer or shorter than the length of the second interval. In addition, the overlapping sustain pulse string and non-overlapping sustain pulse string may be alternated several times in the sustain period. Such a setting of the lengths and repetition of the first and second intervals may be predetermined by a circuit designer. Alternatively, such setting may be designed so that the application of the overlapping sustain pulse string may vary depending on a load, considering that the stability of the sustain discharge may vary depending on the load.

In addition, according to an exemplary embodiment of the present invention, the overlapping sustain pulse string may be employed as a sustain pulse string that is finally applied to the scan electrode Y and the sustain electrode X in the sustain period, and in this case, the address discharge failure in an address period of a subsequent subfield may be prevented.

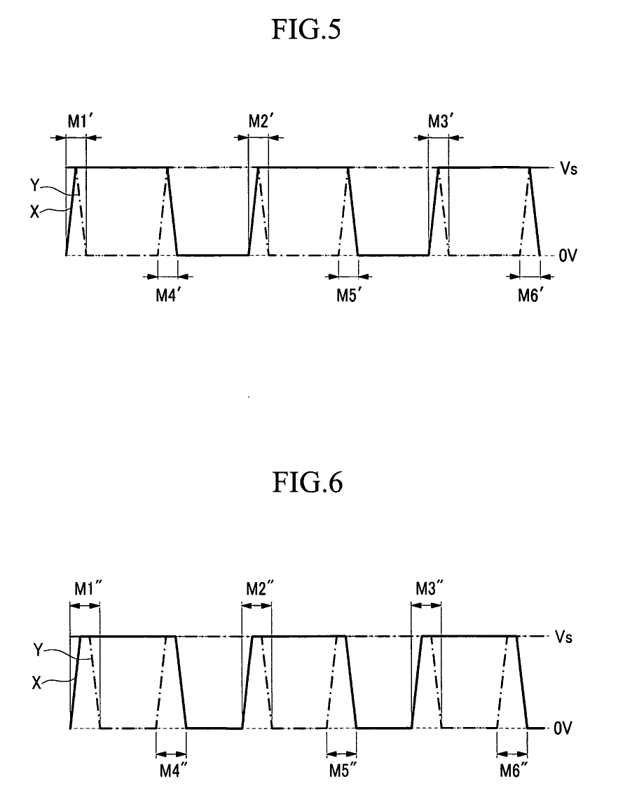

Examples of different overlapping sustain pulse strings according to other embodiments are described in detail with reference to FIG. 5 and FIG. 6. In FIG. 5 and FIG. 6, the voltage of the sustain electrode X is illustrated as a solid line, and the voltage of the scan electrode Y is illustrated as a dotted line, as in FIG. 4.

FIG. 5 illustrates another exemplary overlapping sustain pulse string according to an exemplary embodiment of the present invention.

Differently from the overlapping sustain pulse string of FIG. 4, the overlapping sustain pulse string of FIG. 5 may maintain the voltage of the scan electrode Y at the Vs voltage during the entire rising period of the sustain electrode X. The falling period of the scan electrode Y may start when the voltage of the sustain electrode X reaches the Vs voltage. That is, the sustain pulses may overlap from a start of the rising period of the sustain electrode X to an end of the falling period of the scan electrode Y, i.e., during periods M1′ to M3′ in FIG. 5. In addition, the voltage of the sustain electrode X may remain at the Vs voltage during the rising period of the scan electrode Y, and the falling period of the sustain electrode X may start when the voltage of the scan electrode Y reaches the Vs voltage. That is, the sustain pulses may overlap from a start of the rising period of the scan electrode Y to an end of the falling period of the sustain electrode X, i.e., during durations M4′ to M6′ in FIG. 5. The sustain electrode X and the scan electrode Y may be at the Vs voltage simultaneously.

In comparison with overlapping durations M1-M6 of the overlapping sustain pulse string in FIG. 4, overlapping durations M1′-M6′ of the overlapping sustain pulse string in FIG. 5 are longer, i.e., the voltage of the sustain electrode X and the voltage of the scan electrode Y overlap each other for a longer time. Therefore, the probability of self-erasing may be further decreased, and thus, the sustain discharge may become more stable.

FIG. 6 illustrates still another exemplary overlapping sustain pulse string according to an exemplary embodiment of the present invention.

Differently from the overlapping sustain pulse strings of FIG. 4 and FIG. 5, the overlapping sustain pulse string of FIG. 6 may maintain the voltage of the scan electrode Y at the Vs voltage during the rising period of the sustain electrode X, and the falling period of the scan electrode Y may start at a predetermined time after the voltage of the sustain electrode X reaches the Vs voltage. In addition, the voltage of the sustain electrode X may remain at the Vs voltage during the rising period of the scan electrode Y, and the falling period of the sustain electrode X may start at a predetermined time after the voltage of the scan electrode Y reaches the Vs voltage. Thereby, overlapping durations M1″-M6″ of the overlapping sustain pulse string in FIG. 6 become longer than the overlapping durations M1′-M6′ of the overlapping sustain pulse string in FIG. 5, and a period during which the sustain electrode X and the scan electrode Y are at the Vs voltage simultaneously may be longer than that shown in FIG. 5. Therefore, the probability of self-erasing may be further decreased, and thus, the sustain discharge may become more stable.

According embodiments, a sustain discharge becomes more stable, and thereby, discharge spots and bright image sticking may be improved, while the power efficiency may be maintained.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A driving method of a plasma display device having a plurality of first, second, and third electrodes, and a plurality of discharge cells defined by the plurality of first, second, and third electrodes, the plurality of third electrodes extending in a direction that crosses the plurality of first and second electrodes, the method comprising:
erasing wall charges of a turn-off cell selected from among the plurality of discharge cells by applying an address voltage to a third electrode corresponding to the turn-off cell in an address period; and
applying a first pulse string to the plurality of first electrodes and a second pulse string to the plurality of second electrodes in a sustain period, the first pulse string alternating between a first voltage and a second voltage higher than the first voltage, the second pulse string alternating between the first and second voltages, but having a different alternating timing than the first pulse string,
wherein the sustain period includes an overlapping duration in which voltages of the first and second pulse strings are simultaneously higher than the first voltage.

2. The driving method as claimed in claim 1, wherein the overlapping duration comprises at least one of a first period where a rising period of the first pulse string and a falling period of the second pulse string partially overlap each other, and a second period where a falling period of the first pulse string and a rising period of the second pulse string partially overlap each other.

3. The driving method as claimed in claim 1, wherein the overlapping duration comprises at least one of a first period where a rising period of the first pulse string and a falling period of the second pulse string entirely overlap each other, and a second period where a falling period of the first pulse string and a rising period of the second pulse string entirely overlap each other.

4. The driving method as claimed in claim 1, wherein, during at least one of a first period, a rising period of first pulse string and a falling period of second pulse string simultaneously begin at the second voltage, and a second period, a falling period of the first pulse string and a rising period of the second pulse string simultaneously begin at the second voltage.

5. The driving method as claimed in claim 1, wherein the overlapping duration comprises a period during which voltages of the first pulse string and the second pulse string are simultaneously at the second voltage.

6. The driving method as claimed in claim 1, wherein the overlapping duration comprises a period where a voltage of a final pulse of the first pulse string and a voltage of a final pulse of the second pulse string are higher than the first voltage.

7. The driving method as claimed in claim 1, wherein the sustain period further comprises a non-overlapping duration in which both voltages of the first pulse string and the second pulse string are simultaneously at the first voltage.

8. The driving method as claimed in claim 7, wherein the non-overlapping period occurs before the overlapping period.

9. The driving method as claimed in claim 7, wherein the non-overlapping period and the overlapping period have a substantially same duration.

10. The driving method as claimed in claim 7, wherein the non-overlapping period and the overlapping period alternate during one sustain period.

11. A plasma display device, comprising:
a plasma display panel having a plurality of first, second, and third electrodes and a plurality of discharge cells defined by the plurality of first, second, and third electrodes, the plurality of third electrodes extending in a direction that crosses the plurality of first and second electrodes; and
a driver coupled to the first, second, and third electrodes,
wherein the driver is configured to:
erase wall charges of a turn-off cell selected from among the plurality of discharge cells by applying an address voltage to a third electrode corresponding to the turn-off cell in an address period; and
apply a first pulse string to the plurality of first electrodes and a second pulse string to the plurality of second electrodes in a sustain period, the first pulse string alternating between a first voltage and a second voltage higher than the first voltage, and the second pulse string having the same pattern as, but a different alternating timing from, the first pulse string,
wherein the sustain period includes an overlapping duration in which voltages of the first and second pulse strings are simultaneously higher than the first voltage.

12. The plasma display device as claimed in claim 11, wherein the overlapping duration comprises a period where a voltage of a final pulse of the first pulse string and a voltage of a final pulse of the second pulse string are higher than the first voltage.

13. The plasma display device as claimed in claim 11, wherein the sustain period further comprises a non-overlapping duration in which both voltages of the first pulse string and the second pulse string are simultaneously at the first voltage.

14. The plasma display device as claimed in claim 13, wherein the non-overlapping period occurs before the overlapping period.

15. The plasma display device as claimed in claim 13, wherein the non-overlapping period and the overlapping period have a substantially same duration.

16. The plasma display device as claimed in claim 13, wherein the non-overlapping period and the overlapping period alternate during one sustain period.

17. The plasma display device as claimed in claim 11, wherein the overlapping duration comprises at least one of a first period where a rising period of the first pulse string and a falling period of the second pulse string partially overlap each other, and a second period where a falling period of the first pulse string and a rising period of the second pulse string partially overlap each other.

18. The plasma display device as claimed in claim 11, wherein the overlapping duration comprises at least one of a first period where a rising period of the first pulse string and a falling period of the second pulse string entirely overlap each other, and a second period where a falling period of the first pulse string and a rising period of the second pulse string entirely overlap each other.

19. The plasma display device as claimed in claim 11, wherein, during at least one of a first period, a rising period of first pulse string and a falling period of second pulse string simultaneously begin at the second voltage, and a second period, a falling period of the first pulse string and a rising period of the second pulse string simultaneously begin at the second voltage.

20. The plasma display device as claimed in claim 11, wherein the overlapping duration comprises a period during which voltages of the first pulse string and the second pulse string are simultaneously at the second voltage.
